(19) United States
(12) Patent Application Publication
(10) Pub. No.: US 2008/0296223 A1
(43) Pub. Date: Dec. 4, 2008

(54) BIOREMEDIATION METHODS USING FUNGAL COMPOSITIONS

(76) Inventor: Bryan HIROMOTO, Honolulu, HI (US)

Correspondence Address: MORRISON & FOERSTER LLP, 12531 HIGH BLUFF DRIVE, SUITE 100, SAN DIEGO, CA, 92130-2040, US

(21) Appl. No.: 12/130,860

(22) Filed: May 30, 2008

Related U.S. Application Data
(60) Provisional application No. 60/940,937, filed on May 30, 2007.

(51) Int. Cl. C02F 1/00; A62D 3/02

(52) U.S. Cl. 210/632; 435/262.5

(57) ABSTRACT

The invention provides compositions derived from brown-rot fungi that are suitable for use in bioremediation and similar applications where it is desirable to transform a target compound, often a toxic organic compound, into a different compound or compounds having more acceptable properties. The compositions are suitable for treating aqueous solutions or suspensions to reduce the amount of an undesired organic compound present, usually as one step in a treatment process to render the solution or suspension more suitable for environmental release. The invention also provides improved methods for growing fungal cultures for production of culture fluids.

This application claims benefit of priority to U.S. Provisional Application Ser. No. 60/940,937, filed May 30, 2007, and the contents of that application are incorporated herein by reference.

### TECHNICAL FIELD

This application relates to methods for at least partially removing undesired organic compounds from a mixture using a composition produced by a brown rot fungal culture. The methods are useful for reducing concentrations of certain organic contaminants, including aromatic compounds that may impart toxicity or undesirable coloration, in materials such as aqueous waste streams or by-products from the processing of plant materials.

### BACKGROUND ART

Many agricultural and industrial processes produce waste streams or by-products that contain compounds that should not be released into the environment, or at least should not be released in concentrated form. Production of pulp for paper manufacturing, for example, produces a smelly dark-colored material from the pulping and bleaching processes: the waste stream needs to have both color and potentially toxic organics removed before it can acceptably be released as surface water. This waste stream includes a variety of organic compounds, including lignins and chloro-lignins, dioxins, and furans.

Such waste streams and industrial by-products are often produced in large quantities, usually at the same location, for an extended period of time. Thus it is often difficult to dispose of these materials due to long-term accumulation or chronic impact on the environment, even if the amount produced at any one time is not harmful. Transport of such materials is also prohibitively expensive if the quantity of such material is large, even though the amount of undesirable impurities present in the material is relatively small. Consequently, many methods for removing, detoxifying, or diluting harmful materials in waste streams have been devised.

One relatively common means for reducing the amount of a contaminant in a waste stream is to provide a microorganism that is capable of consuming or modifying the contaminant, and treating the waste stream or by-product with that microorganism under conditions that effect at least partial removal of the harmful material(s) present. Though bacteria, including engineered ones, are most commonly used, the use of fungi is also precedented for such treatments. D'Annibale A., Casa R., Pieruccetti F., Ricci M., Mrabottini R., “Lentinula edodes Removes Phenols from Olive-mill Wastewater: Impact on Durum Wheat (Triticum durum Desf.) Germinability,” Chemosphere 54(7): 887-894 (2004). This method of reducing levels of potentially harmful contaminants is often referred to as bioremediation, and it can potentially be applied as a step in a production process or as a means to reduce the amount of harmful material that has already been released into the environment, as in a chemical spill, for example. Lignin degradation by white rot fungi is well recognized as one such bioremediation method that may be useful especially in the treatment of waste streams from paper production or agricultural product processing.

A number of particularly useful enzymes produced by various microorganisms have been identified. Chung N., Lee 1I-S., Song H-S. and Bang W-G., “Mechanisms used by white-rot fungus to degrade lignin and toxic chemicals”, Journal of Microbiology and Biotechnology 10: 737-752 (2000). Certain of these enzymes that are useful for bioremediation can readily be observed in microorganism cultures using model substrates whose degradation is easily observed: for example, a colored dye known as Poly R-478, which bears some similarity to lignins, changes color when it is transformed by a biological oxidation caused by lignin peroxidase. Tucker, et al., “Suppression of Bioremediation by Phanerochaete chrysosporium by Soil Factors”, Journal of Hazardous Materials 41(2-3): 251-265 (1995). Thus Poly R-478 is a model compound useful to identify fungal or microbial cultures capable of degrading colored organics and related molecules with aromatic structures, including benzo[a]pyrenes.

It has long been known that white rot fungi are useful for bioremediation; however, they are generally believed to be the only fungal organisms with such utility. (“The only organisms capable of mineralizing lignin efficiently are basidiomycetous white rot fungi and related litter-decomposing fungi.” -A. Dhoubi, et al., African J. Biotechnology 4(5), 431-36 (2005), citing a 2001 paper.) Brown rot fungi grow more slowly, and are believed to decay wood largely by production of hydrogen peroxide formed from degradation of hemicellulose rather than by direct action on cellulose. Their cultures are thus typically considered unsuitable for uses where the growing fungus is needed for remediation, although at least one source reports the use of a brown rot fungus culture for remediation. U.S. Patent Application No. 2004/0211721.

It has now been shown that certain brown-rot fungi produce useful quantities of enzymes effective for bioremediation and exude those enzymes into the culture fluid in which the fungus is grown. For example, a culture fluid isolated from broths of Laetiporus sulphureus and used as a fertilizer (sold as “Maui LCF”: LCF stands for liquid compost factor) has now been shown to decolorize Poly R-478, demonstrating its capacity to degrade a compound resembling lignin, and demonstrating the presence of useful amounts of enzymes capable of providing bioremediation. (Maui LCF is described in Economic Development of Hawaii, “Activities Underway in 2003”, available online at http://www.epa.gov/oppbppd1/PESP/publications/vol6se/IIIF-edah.htm. This fluid from composting of plant materials with L. sulphureus in an aqueous milieu, typically in large drums, is heated to boiling (100° C.) to denature certain proteins, then filtered to remove solids, and is sold as a brown solution without further purification. Maui LCF is applied to the soil where plants or seeds have been, or will be, introduced, as a fertilizer or fertilizer additive; it provides nutrients and plant growth regulatory compounds.) Poly R-478 dye was added to LCF in various combinations of dilutions. FIG. 1 shows that Maui LCF decolorizes the Poly R-478 dye at a concentration-dependent rate, and thus displays lignin peroxidase-like activity. This demonstrates that culture fluids produced by brown rot fungi (also referred to as “cubic rot fungi”), and compositions prepared from such culture fluids, can be used for bioremediation, even if the corresponding live fungus might have limited value for such applications.

The use of a culture fluid containing the needed enzymes for bioremediation has numerous advantages over the use of a growing fungal culture. A growing culture introduces a wide range of materials into the very waste stream or by-product that is to be treated; a culture fluid can be partially purified so that it introduces far less material into the treated sample. A growing culture also requires a certain amount of miscellaneous nutrients that may not be present in the sample to be treated, and may thus have to be introduced in order for the culture to function efficiently; a culture fluid has no such requirement. The culture fluid is also typically easier to use and transport than a growing culture, and may be much less temperature and pH sensitive. It is also potentially useful where a fungal culture would be overrun by other microorganisms. Thus a culture fluid containing the desired bioremediation enzymes may be useful where a growing fungal or microbial culture would be impractical.

### DISCLOSURE OF THE INVENTION

Thus in one aspect, the invention provides a bioremediation composition prepared from a culture fluid that is produced by a brown-rot fungus grown on a substantially aqueous medium. Brown rot fungi, or cubic rot fungi, are distinguished from white rot fungi by the way they degrade wood, rather than along genus or species lines: brown rot fungi only degrade cellulose and hemicellulose, and are typically unable to degrade lignin. As a result, when brown rot fungi consume wood they leave a brown residue rich in lignins, while white rot fungi have the ability to degrade lignin as well as the cellulose and hemicellulose of woody plants, and leave behind a nearly white residue containing little lignin. Brown rot fungi include, for example, Coniophora puteana, Postia placenta, Neolentinus lepideus, Gloeophyllum trabeum, Serpula incrassate, Antrodia xantha, Laetiporus sulphureus, Antrodia carbonica, Antrodia serialis, Antrodia vaillantii, Fomitopsis palustris, Phaseolus schweinitzii, and Fomitopsis pinicola.

The bioremediation compositions comprise various substances, mainly enzymes, produced by the growing fungus and is useful for its ability to transform or degrade certain types of organic compounds, such as aromatic compounds including phenols, anisoles, furans and the like, into different materials that are less deleterious. The organic compounds to be transformed or degraded include organic contaminants in various samples such as waste streams from industrial processes or from processing of agricultural or forestry products, as well as contaminated water or soil such as those affected by a chemical spill.

In another aspect, the invention provides methods to treat samples such as contaminated waste streams or surface or well water containing small amounts of organic contaminants with a fungal-derived composition that at least partially degrades or transforms the organic contaminants into new chemical species that are less deleterious in the particular setting. The compositions of the invention are used by mixing them with a sample to be treated, typically as a solution, suspension or slurry that is aqueous or substantially aqueous in character. The mixture so formed is then maintained under suitable conditions to allow the active bioremediation substances provided by the composition to at least partly degrade, or to reduce the concentration of, at least one organic contaminant present.

The culture fluid-derived compositions of the invention are typically used to transform an undesired organic material that is difficult to separate from its environment, such as a toxic substance that is in a large quantity of water or sludge, into a different chemical species that is less deleterious in the particular environment. The organic compound or contaminant to be transformed or degraded may be toxic or colored, for example; the method results in transformation of the compound into one that is less toxic or less strongly colored. Thus the effect of the undesired organic material on its environment or on a sample containing it is reduced or remediated, at least in part, by the transformation effected by the composition of the invention.

The compositions are thus useful to reduce the concentration of an organic contaminant in an aqueous or substantially aqueous sample by mixing the sample with a bioremediation composition of the invention, and maintaining the mixture under suitable temperature conditions to allow the active enzymes in the composition to at least partially degrade the organic contaminant into one or more less new chemical species that are less harmful or deleterious to the sample. Often, a reduction in concentration of the contaminant of at least about 50% can be achieved by such treatment within a matter of days or weeks. Frequently, the composition causes a hydrolysis reaction or an oxidation reaction of the organic contaminant to occur.

In another aspect, the invention provides an improved method for growing a fungal culture on a substantially aqueous medium in a large container such as a barrel, drum or vat, that comprises providing additional growing surfaces to support mycelial growth and optionally providing agitation for the medium that mixes the medium and brings it into contact with a growing mycelial mat without substantially disrupting the mat structure.

### BRIEF DESCRIPTION OF THE DRAWINGS

FIG. 1 illustrates that Maui LCF decolorizes Poly R-478 in a dose-dependent manner. It shows how the rate of decomposition of this substance, which is tracked by measuring the rate of decolorization of Poly R-478 by tracking the change in absorption (AU=absorption units), depends upon the amount of Maui LCF used.

### MODE OF CARRYING OUT THE INVENTION

A ‘culture fluid’ as used herein refers to an aqueous mixture obtained by removing most of the solids from a growing medium that was used to raise a brown rot fungal culture for at least several weeks. The growing medium, as further explained below, is an aqueous suspension comprising suitable nutrients and carbon sources to support the growth of a mycelial mat of the fungus of interest: typically, it is a solution/suspension that comprises fruit and vegetable residues, fruit juices, and other materials such as cereal products and sugars that are digestible by the fungus culture. The medium thus provides nutrients and carbon sources adequate to support the growth of a fungal culture.

While the fungus grows, it modifies the medium both by consuming the nutrients initially present and by depositing substances into the medium through various mechanisms. The fungal culture typically undergoes an initial growing phase before it produces substantial amounts of the bioremediation active substances (mainly certain enzymes), so the medium contains only minor amounts of these enzymes during the initial growing phase. However, over time these active substances accumulate in the medium, so after a few weeks, the medium contains substantial amounts of such activity, in the form of enzymes produced by the fungus culture and released into the medium by undetermined mechanisms. Once these activities build up in the medium, they can be harvested by separating some or all of the aqueous medium from the growing fungus: once separated from the fungus, the solution containing the active substances useful for bioremediation is a culture fluid. Under suitable growing conditions, the bioremediation activity remains or increases in the medium for many weeks thereafter, as long as the nutrient content of the medium remains adequate to support the living fungal culture. It usually remains for at least 60-90 days after the initial growing phase under typical growing conditions. The active substances are collected by harvesting the culture fluid once the desired activity has developed in the medium. The culture fluid may be harvested in multiple batches while the fungal culture continues to grow, as by draining part of the medium from the bottom of the growing container, or it may be harvested in one batch after maturation accompanied by complete removal of the fungus, to produce a culture fluid from which a bioremediation composition of the invention may be prepared. The culture fluid may itself be used for bioremediation, or it may be modified into other compositions as described herein.

In one aspect, the invention provides a bioremediation composition that is useful for removing contaminants from substantially aqueous samples. The compositions are prepared from culture fluids produced by culturing at least one brown rot fungus species on a suitable growing medium. The culture fluid comprises the growing medium in which a brown rot fungal culture has been grown for at least several weeks, and from which most of the fungal matter has been removed. Preferably, the solids have all been removed, and the culture fluid is a solution. In some embodiments, the culture fluid has been treated to remove substantially all fungal cells and spores, or to inactivate substantially all fungal cells and spores. In some embodiments, the culture fluid is processed by heating to about 100° C. to sterilize it and to denature certain proteins: such compositions possess substantial bioremediation activity. In other embodiments, the processing of the culture fluid does not involve heating the fluid or the compositions derived from it above about 80° C or above about 50° C.: this avoids degrading enzymes in the fluid that are needed for bioremediation activity, some of which are at least partly inactivated at higher temperatures.

One embodiment of a brown rot fungal culture fluid suitable for use in the present methods is a culture fluid produced by Laetiporus sulphureus: a culture fluid produced by this organism is produced and sold as “Maui LCF”, and is used as a fertilizer, for its nutrient and growth stimulating effects on green plants. Maui LCF is prepared by collecting the culture fluid from a matured fungal culture grown on a mixture of fruits and fruit juices, heating it to about 100° C. to denature certain proteins, and then filtering it to remove solids. This material decolorizes Poly R-478, demonstrating its ability to degrade certain aromatic compounds, and showing that it can be used for bioremediation.

Maui LCF is still relatively crude, however, and its processing is designed to maximize its fertilizer value rather than its bioremediation activity; different processing methods applied to culture fluids from Laetiporus sulphureus provide superior compositions for bioremediation applications. For example, the culture fluid can be processed without heating, since heating reduces the activity of certain enzymes beneficial for bioremediation. It can be treated to remove some or most of the brown color typically formed during fermentation of L. sulphureus, such as by treatment with activated carbon or charcoal, since a colorless solution may be more acceptable in bioremediation applications. It can also be filtered to remove cells and spores, such as by ultrafiltration using a fine-pore filter like a 0.2 micron filter or a dialysis filtration method. It also can be reduced in volume to a more concentrated solution, such as by evaporation or reduced pressure distillation, or even to a viscous syrup or a solid, as by freeze drying. Preparation of a syrup or solid may be followed by reconstitution if desired, to produce a composition having suitable handling and storage characteristics or having a known concentration. The solids and concentrated solutions provide often require dilution before use, but they provide easier transportation and storage, and easier mixing for large treatments.

The compositions of the invention are typically purified at least enough to be substantially free of cellular components. This means that any fungal-derived insoluble material has been substantially removed from the aqueous culture fluid, as by the purification methods described herein. In some embodiments, the culture fluid is used after it has been filtered or otherwise treated (e.g. by sedimentation, centrifugation, dialysis, etc.) to remove substantially all of the suspended solids present, including the fungal-derived insoluble materials, providing an aqueous solution that is enriched in the active compounds of the invention.

Optionally, the solution is treated by ultrafiltration or by a gel chromatography, dialysis or other conventional process to remove substantially all materials that are above a certain size, such as the size of a cell, or such as an approximate molecular weight of about 100,000, or about 60,000, or about 50,000. These methods remove impurities from the biologically active compounds of interest, and they provide partially purified compositions that can be further purified or concentrated or can be formulated for convenient transportation, storage and use.

In addition, since the bioremediation activity resides in enzymes, low molecular weight materials may also be removed by methods well known in the art, such as by dialyzing or gel filtration chromatography to remove most of the organic compounds with a molecular weight less than about 500, or those with a molecular weight less than about 1000. This step reduces the amount of unnecessary material introduced into a sample to be treated with the methods and compositions described herein.

These compositions may be further purified by, for example, extraction with a water-immiscible organic solvent to remove lipophilic and/or colored materials, or by standard chromatographic methods including gel chromatography to reduce amounts of inactive or undesired material that would otherwise be applied to the treated vegetation. They may also be partially purified by other conventional methods such as decolorization using charcoal or other adsorbents that remove impurities but do not significantly remove the desired bioactive compounds. “Decolorization” as used herein, refers to the removal from an aqueous solution or suspension of at least enough of a dissolved or suspended colored material to significantly lighten or change the color of the aqueous solution. Decolorization provides a material that is better suited to bioremediation where colored materials are likely to cause concern that new contaminants are being introduced along with the treatment.

The term “lipophilic materials” as used herein refers to materials that preferentially distribute into a water-immiscible solvent, permitting them to be partially or substantially removed by extracting them from an aqueous solution using such water-immiscible solvent. Examples of lipophilic materials are compounds that are uncharged at the pH of the aqueous solution being treated and that have a log P greater than about 2 or greater than about 3 at that pH. “Log P” refers to the negative of the logarithm of an octanol/water partition coefficient for a molecule, and is a well-known parameter for evaluating lipophilicity. Methods for measuring or calculating log P values are well known, and methods for such aqueous/organic extractions to remove lipophilic substances from aqueous solutions are also well-known.

The compositions of the invention may be substantially dried prior to use, and may then be prepared as a rehydrated solution or suspension, or they may be prepared as a solid such as a dust, or they may be mixed with other solids such as clay, sand, vermiculite, compost, or a soil. The culture fluid may also be admixed with solids without prior drying, and may then be administered either as a slurry or suspension, or the combination may be dried as by evaporation to provide a solid with improved properties relative to those of the residue from evaporation of the culture fluid alone.

The compositions of the invention can be characterized according to the amount of solids present in a sample of the culture fluid or composition derived from a culture fluid as by concentration, etc. One method for doing this is to use the ‘brix’ scale commonly used to denote the concentration of solids, mainly sugars, in grapes to be used for wine production: a ‘one degree brix’ solution contains about one gram of solids per 100 grams of solution. A Maui LCF composition obtained without concentration, for example, typically is less than one degree brix. However, a quart of Maui LCF can readily be concentrated to about an ounce of syrup of about 30 brix; higher brix ratings can be achieved by further concentrating the composition. Compositions are typically concentrated to a consistency that balances transportation costs and handling characteristics: at very high concentrations, the viscosity of the solution makes fluid transfers more difficult. A concentration corresponding to about 10 to about 30 brix is sometimes used.

Similar compositions can be obtained by culturing other brown rot fungal species: each species will provide different mixtures of enzymes with different abilities to degrade organic compounds. Even the composition of the medium on which the culture was raised affects the mixture of enzymes that will be present in the culture fluid, since the medium may contain substances that elicit some degradative enzymes and suppress formation of others.

Typically the composition is used by admixing it with a sample to be treated, usually in an aqueous solution or suspension, and maintaining the mixture at a temperature that supports transformation of the target at a useful rate. Thus for treatment of an aqueous waste stream, the fungal-derived composition may be added to the waste stream with mixing as needed, and the mixture is then maintained at a temperature between 0° C. and about 50° C. until an acceptable end point is achieved. The rate of degradation of the target compound is typically fastest at temperatures between about 15° C. and about 40° C., and an optimum temperature can readily be determined for a specific target compound using standard techniques. Preferably, the mixture is maintained at a temperate within about 5° C. of the optimum temperature for degradation of the particular target compound.

The rate of disappearance of the target compound will depend on many factors, including concentration of the target, amount of the fungal-derived composition used, temperature, and the presence of other substances that may interfere with or compete with transformations of the target compound. Optionally, the disappearance of the target compound or the appearance of products derived from it may be monitored to determine how long to maintain the treatment conditions, and whether additional bioremediation composition needs to be added to achieve the desired level of reduction of the target compound within an acceptable period of time for the particular application.

Methods for producing culture fluids from cultures of such fungi are well known. Optimization of growing conditions for a particular species and bioremediation activity are within the ordinary skill in the art, using assay methods such as those described herein to select a medium with appropriate properties for the particular activity of interest.

In one aspect, the invention provides growing conditions and a liquid medium that enhance the production of the bioremediation active species of the invention. The compositions may be produced under any conditions where the fungi grow at a reasonable rate. Optimum growth conditions for mycelia production were determined for L. sulphureus under stationary conditions. It was observed that the highest mycelium concentration was produced by growing the fungal culture on a suitable medium in 2000 ml Erlenmeyer flasks, pH value of 3.0, and temperature of 30° C. without agitation.

In some embodiments, the growing medium comprises plant-derived carbohydrates such as chopped, diced or pureed vegetables or fruits and/or fruit juices, including processed plant materials such as oatmeal, sugars, agar, and the like in an aqueous suspension or solution. In some embodiments, the medium is supplemented with a vegetable oil such as corn oil, canola oil, or similar plant-derived oils.

A particular combination of readily available and inexpensive materials has been found to enhance production of the desired compositions; it is referred to herein as Rich Broth Medium (RBM). RBM is typically produced by combining the following materials in water: oatmeal, brewer's yeast, corn gluten, molasses, citric acid, and canola oil. A preferred RBM mixture is prepared by mixing 15 g of ground oatmeal, 15 g brewer's yeast, 15 g corn gluten, 1 tsp molasses, 2 g citric acid, and 2 ml of canola oil per liter of water, and sterilizing it in an autoclave before inoculating it with a fungus. Other desirable components for the growing medium include sucrose, malt extract, yeast extract, potato infusion, agar, and the like.

Thus in one embodiment, the invention comprises a composition as described herein that is produced by growing a brown rot fungal species on RBM or a substantially similar medium. Preferred fungal species include L. sulphureus.

Alternatively, the fungus of interest may be cultured on other known media such as Potato Dextrose Broth, or a substantially similar medium. This medium comprises potato infusion and dextrose, and may be used at a pH of about 5.1 or at a pH optimal for the particular application, and is well known in the art.

Combinations of the components of these media, additional materials that may beneficially be added to provide a balanced growing medium for a particular fungal species, and other similar nutrient sources will be apparent to the skilled artisan from the growing methods described herein, and use of media containing those substances to produce the compositions described herein is also within the scope of the invention. Optimization of the medium used for a given fungus can be guided by measuring the rate of fungus growth, such as by tracking growth by measuring the dry weight of the fungal mass produced; or by measuring the bioremediation activity in the medium or a culture fluid prepared from the medium, such as by using the decolorization of Poly R-478 as an index of the activity; or it can be tracked by measuring the rate of consumption of digestible carbohydrates from the medium, as by measuring the decrease in dissolved solids by measuring the brix rating of the medium over time. Each of these provides an easy way to determine which culture conditions are most suitable for a particular fungus growing on a particular medium, such as for selection of a suitable carbon source for growing the culture. Each of these can also be used to determine how long to maintain the culture before its culture fluid is harvested: harvesting would typically occur when fungal growth rate reached a plateau, or when the bioremediation activity of the culture reached a plateau or began to decline, or when the brix rating of the solution leveled off. In one embodiment, the initial brix rating of the medium dropped from about 3 to less than 1 (about 0.8), at which time the Laetiporus sulphureus culture fluid was harvested.

When scaling up production to large scale, one of the factors that most limits fungal growth is the availability of suitable surfaces for mycelia to cling to. Typically, for producing a large volume of the compositions of the invention, a culture is grown in a barrel or similar container for about 30 days before a substantial amount of bioactive substance is present in the culture fluid; maximum production of the bioactive species may require maintaining the culture for another 30-60 days. The fungus typically grows preferentially in contact with the walls of the container in which the medium is placed, and generally it will grow up the sides of the container, often for a considerable distance. It has now been found that providing additional growing surface area, in addition to that provided by the container itself, accelerates the rate of growth of the fungus and the rate of bioactive substance production in a given volume of medium. It can also shorten the cycle time for growing batches of culture fluids using the culture methods described herein. This improved method can be used for many types of fungal cultures, and is especially useful for growing production scale cultures of Basidiomycete fungi, brown rot fungi, and Laetiporus sulphureus in particular.

The growing container for a fungal culture used to produce large quantities of the compositions of the invention is typically a barrel or vat or similar container, made of a material that is suitable for holding an aqueous medium containing materials essential for fungal growth. Various plastics, glass, PLEXIGLAS®, fiberglass, and certain metals are suitable materials for such containers. Typically, however, these containers provide a relatively low surface area to volume ratio when the medium depth is more than a few inches, and it has been found that the rate of growth and of production of the bioactive species of the compositions of the invention increase when the surface area to volume ratio increases. For large scale production, it is preferable to increase the depth of the medium as much as possible in order to maximize the utilization of growing space and light, while producing as much of the culture fluid as possible in each batch. Many fungal cultures suitable for producing the compositions of the invention can be grown efficiently with medium depths much greater than a few inches, and of course the surface area to volume ratio usually drops as the medium depth is increased. Often it is beneficial to provide room for more extended mycelia mats and increasing the surface area available to support mycelial mat growth. Thus it has now been demonstrated that the growth rate of the culture and the rate of production of the bioactive species of the invention both increase when medium depth exceeds a few inches if additional growing surfaces are provided.

In certain embodiments, the invention thus provides additional growing surfaces that are typically substantially vertical and that extend from at or above the surface of the growing medium through the surface of the growing medium and down into the medium, at least part of the way to the bottom of the container in which the fungal culture is grown. In some embodiments, the additional surface area is provided by suspending components from above the surface of the medium so that they hang down into the medium; in others, the additional surface area is provided by surfaces that float or are supported by material that floats on top of the medium. In other embodiments, the structure(s) providing additional growing surfaces extend from the sides or from the bottom of the container into the medium, and usually they extend through the surface of the medium and upwards above the medium to provide additional growing surface that is above the medium but in fluid contact with the medium. The most benefit is obtained from structures that extend upward from the surface of the medium, so that the additional growing surface is in contact with the medium so that it remains moist either from direct contact with the medium or from contact with mycelia that reach into the medium and grow upward from the medium surface.

Often, the additional growing surfaces are in the shape of rods, flat plates, strips, tubes, or cylinders; they may also be provided by fin-like projections that extend from the sides or bottom of the container or both. In one embodiment, the additional growing surfaces are provided by a plurality of plates of e.g. PLEXIGLAS™ that are suspended from a lid that is used to cover a drum or barrel or other container in which the fungal culture is grown. Optionally, the plates may be interconnected such as in a checkerboard pattern, and there may be at least one corresponding structure extending from the bottom or side of the container to stabilize the additional growing surface structures when they are so suspended, providing improved stability. Having the additional growing surfaces held relatively stationary is beneficial to the growing fungi, since movement of the growing support can damage the fungus once it is established. However, the shape of the additional growing surface and how it is supported or held in place is unimportant, as long as it provides support for growing mycelia.

The amount of additional growing surface is not critical: any additional growing surface provides some benefit. However, it is often desirable to increase the available surface area by at least about 50% or by 100% or more. In some embodiments, for example, a 208 liter drum is used to contain a culture, and it is charged with about 113 liters of medium. In a vertical orientation, i.e. when standing upright, it has a surface area/volume ratio of about 22 cm²/liter. When placed on its side, that ratio increases to about 42 cm²/liter. However, addition of a few plates of additional growing surface material as described herein can easily double or triple the available surface area; and the use of a porous material may provide even greater increases in surface area.

The additional growing surface is constructed of material that is suitable to support fungal growth above and/or below the medium surface, and optionally the material used for the additional growing surfaces may be sanded, scratched, scraped or otherwise roughened to encourage the fungus to adhere to and ‘climb up’ the additional growing surfaces. In some embodiments where the surface is otherwise a relatively smooth solid like PLEXIGLAS™, it is advantageous to apply vertical scores, grooves or scratches: these encourage upward growth of fungus away from the medium, and may provide a degree of capillary action to encourage moisture to travel upward from the medium, further encouraging the fungus to grow beyond the surface of the medium. Instead of a solid surface, the additional growing surface can also comprise a porous or absorbent material such as a cloth, sponge, or mat that may be composed of a plastic or fiberglass, for example; or it may be in the form of a perforated plate or a mesh or screen.

Preferred materials for the additional growing surfaces are those suitable for long-term exposure to an aqueous growing medium useful for supporting fungal growth; typically this includes the same materials used for construction of the containers in which the cultures are grown. Stainless steel, polyethylene, polypropylene, polystyrene, nylon, polyvinyl chloride, fiberglass, polyurethane, and TEFLON™ can all be used, for example. Stainless steel mesh or screen works well, as do polypropylene mats, cured polyurethane foam such as acoustic material, and TEFLON™. Each of these is sometimes a preferred material. Combinations of these materials and of their shapes and textures may be employed, and different methods for holding them in place can be combined as well.

The medium may be agitated by stirring or bubbling gas through it, for example. In a particular embodiment, however, the medium was not agitated. Instead, it was maintained as a very shallow suspension, where the culture was not over about 1-6 inches deep, or about 2 inches, or about 3 inches, or about 4-5 inches deep: if a deeper suspension is used and the culture depth is significantly greater than 6 inches, some form of agitation or aeration may be used.

For larger scale production, it is sometimes preferred to agitate the medium. Significant improvement in growth for large scale production is sometimes achieved when suitable agitation is used to mix the growing medium and to increase contact of the medium with the mycelia, without unduly disturbing the mycelial mats. This is beneficial because a stationary culture tends to have some of the medium that is not in contact with the fungus, and thus neither provides nutrient to the fungus nor receives exudates that include the bioactive chemical species of interest. This mixing can be achieved by gentle agitation of the medium in which the fungus grows or by bathing the fungal growth above the medium with the growing medium. In some embodiments it is accomplished by a lifting pump system that takes medium from near the bottom of the growing container, or at least from a point below the majority of the fungal growth at the particular growth stage, and distributes it over the growing fungus. The medium can be sprinkled, dripped or sprayed onto the growing fungal mat, or it can be allowed to flow gently enough over the growing fungus to avoid disruption of its growth. It can also simply be redirected into the medium in a way that encourages mixing, e.g. it can be returned to the container at a point sufficiently removed from the point where it is taken in by the pumping system so that the net result is a gently current within the medium. Alternatively, a subsurface pumping system or mixing device such as a stirring mechanism can be used to gently direct fluid that is not in contact with the mycelia into or onto the mycelial mat from below, without unduly disturbing the mat structure, or at least to agitate the medium beneath a growing mycelial mat. In this way, a relatively small growing culture can produce a large volume of culture fluid containing the compositions of the invention.

As different materials and shapes of such additional support surfaces and different fluid mixing or redistribution arrangements may be preferred depending upon the specific fungus used, the growing conditions and medium, and the depth of the medium, it may be necessary to select a suitable combination of these features when scaling up production of a particular culture. Methods provided herein can be used to determine which conditions provide the greatest amount of a desired remediation activity.

The length of time for growing the fungal culture on the liquid medium to optimize the yield of the active substances of interest depends on a variety of factors, including the medium, pH, temperature, and fungal species employed. The precise time is not critical to the successful generation of the active compositions, as they are substantially stable under the culture conditions once produced. Typically the growing phase will last at least several days to a week; in some embodiments it is about two weeks; and in some it is advantageous to maintain the culture for about three weeks or about four weeks or up to about 60 days. In some embodiments the culture is maintained at least five weeks, and in some embodiments it is maintained six weeks or longer. Once the growing phase has been completed, the culture fluid may be harvested, though it is not critical to harvest the fluid immediately.

Thus in one embodiment, a brown rot fungus may be grown at a temperature of about 30° C. and a pH of about 3, in RBM, without aeration or agitation, preferably in a shallow mixture less than about 6″ deep. In another embodiment, a a brown rot fungus may be grown at a temperature of about 30° C. and a pH of about 3, in RBM or a similar medium in barrels, drums or vats having additional growing surfaces provided, and optionally with an agitation method such as those described above.

The culture fluid is harvested by draining or decanting the medium from the growing mycelial mat before use, or by removing the majority of the fungal growth by mechanical separation means such as filtration or centrifugation. Typically, the harvested culture fluid is at least partially purified before use. In some embodiments, solids are removed by, e.g., sedimentation, filtration, or centrifugation or some combination of these. Optionally, the solution may also be sterilized by known methods such as heating and/or filtration or ultrafiltration to provide an aqueous solution that may be sterile. Preferably, sterilization is done by filtration with a membrane such as a 0.22 micron membrane, or by UV or gamma irradiation, to minimize damage to the enzymes of interest. Effective sterilization may also be achieved by lyophilization. Combinations of isolation and purification methods may also be employed to provide other compositions that are at least partially purified relative to the crude medium. Further purification of the culture fluid may also be undertaken as desired, using methods known in the art based on the information provided herein about the structure and stability of the active compounds.

The culture fluids of the invention are useful for removing a variety of organic compounds from a wide variety of samples. Because the degradation process is enzyme mediated, the methods are most useful in a substantially aqueous medium, where such enzymes are stable and functional. Many enzymes may be present in a culture fluid produced as described herein, and it is possible to characterize a culture fluid based on its enzyme composition in order to ascertain which types of organic compounds it will be most useful to remove or degrade. Typically, the culture fluid will oxidize relatively electron rich aromatic compounds such as phenols, anisoles, and furans: phenols, which tend to be toxic, water soluble and relatively reactive, are often particularly suitable for removal by the present methods. Similarly, anisoles are often odoriferous and electron rich; thus their removal from waste streams or by-products is particularly desirable, and they tend to be susceptible to degradation by enzymes present in the culture fluids of the invention. Thus anisoles and phenols are often suitable target compounds for removal using the methods and compositions described herein.

Methods for using a culture fluid from a fungal culture for bioremediation will be apparent to those of ordinary skill in the art. Some experimentation may be required in order to optimally remove a specific target compound from a particular sample, since each sample has unique composition, and each remediation project has different requirements and must be performed under different conditions. Once a target compound to be removed has been identified, that compound may be treated with a fungal culture fluid-derived composition of the invention to determine whether the rate of degradation of the particular target compound is fast enough to be useful. Methods for determination of the degradation rate of organic compounds are well known, and do not necessarily even require determination of the structure of the target compound: its degradation rate can be determined from the rate of its disappearance from a sample, using a conventional analytical method such as HPLC or GC. Measurements of the rate of disappearance of the target compound can be used to adjust the dosage of the culture fluid composition that should be used to effect an adequate reduction in the concentration of the target compound within an acceptable period of time, and to optimize temperature and pH for the process. In most cases, one or a few specific degradation products will be formed by the action of the culture fluid enzymes on the target compound, and it is sometimes easier to monitor the rate of transformation of the target compound by tracking the formation of the new product(s) instead of monitoring disappearance of the target compound itself.

Typically, the methods of the invention are effective to reduce the concentration of a target compound that contains at least one electron-rich aromatic ring and resides in a substantially aqueous mixture. Where the target compound contains one or more phenol, anisole or furan ring, the methods of the invention can typically be optimized to reduce the concentration of the target compound by at least about 50% from its initial value. In some cases, the target compound concentration can be reduced by at least 70% or by at least 80% or by 90% or more from its initial value using these methods and compositions.

Where a particular contaminant has been identified as the target compound for a bioremediation method, a fungal culture can be adapted to effectively degrade the target compound by exposing the fungal culture to that compound for a period of days or weeks. This often elicits the culture to adapt itself to utilize the target compound by producing enzymes effective for the degradation of the specific target compound. This can enable the fungus to degrade the target compound into a useful source of nutrients or energy, and it increases the effectiveness of the culture fluid for its intended use.

The following examples are offered to illustrate but not to limit the invention.

### Fungal Culture Conditions for Producing Culture Fluids

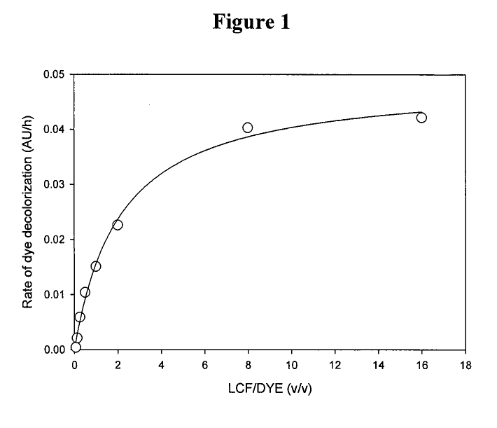

Once the cultivating conditions for growth of L. sulphureus were optimized, the following conditions were used to produce bioactive culture fluids. The experiments were performed in 2000 ml Erlenmeyer flasks containing 200 ml of media, thus limiting the depth of the medium to less than about 2-4 inches. Media were autoclaved for 20 minutes at 121° C. After cooling to about 50° C., flasks were inoculated with 5 pieces (cut with a 1 cm diameter No. 8 core borer) of actively growing mycelia from 14-day-old RSM cultures. Flasks were incubated for 21 days at 30° C. After incubation, culture fluids were harvested by centrifugation at 14,000 rpm for 15 minutes at 4° C., and filter sterilized with 0.22 μm filters (Membrane filters, Isopore™, Ireland). Culture fluids were tested for their bioremediation activity using the Poly R-478 method as outlined in Tucker, et al., “Suppression of Bioremediation by Phanerochaete chrysosporium by Soil Factors”, Journal of Hazardous Materials 41(2-3): 251-265 (1995). FIG. 1 summarizes the results obtained with Maui LCF.

### Optimum Conditions for Mycelial Growth

Growth conditions of surface area, pH, and temperature of the culture medium affected mycelial growth of L. sulphureus and other brown rot fungi. Increased surface area of the media/air interface resulted in increased biomass of most fungi. At 25° C. the greatest amount of mycelial growth occurred with cultures grown in 2000 ml Erlenmeyer flasks after 21 days of incubation under the conditions described above. The lowest mycelium concentration was observed in 250 ml flasks. There was no significant difference between 500 ml and 1000 ml Erlenmeyer flasks, which showed similar results and were significantly less than the 2000 ml flask cultures. These demonstrate that a shallow growing medium is advantageous, and typically the medium is not over about 6″ in depth, preferably less than 5″ or less than 4″ in depth. In some embodiments, the medium is at a depth not over 3″.

Mycelial growth of most brown rot fungi is favored by lower pH's of the culture media. The greatest amount of mycelial growth was observed at a pH of 3. At media pH's of 4, 5 and 6, mycelial growth was over 30% less than the growth observed at a pH of 3 for L. sulphureus. The optimum temperature for each culture depends on the medium and the fungal species: for L. sulphureus, the optimum is about 30° C. typically.

### Improved Large Scale Culture Fluid Production Method

Cultures of L. sulphureus were grown in PYREX® containers both with and without an added piece of polyurethane foam to provide additional growing surface. It was estimated that the foam tripled the growing surface area relative to the PYREX® container alone. The concentration of sugars in the growing medium was tracked for two months by periodically measuring the brix of the medium. Brix is a parameter used to monitor sugar content in growing grapes, and indicates the approximate concentration of dissolved solids in an aqueous mixture. The culture with the added polyurethane foam consumed sugars from its medium at about three times the rate of the culture without the added polyurethane foam, indicating that it was growing roughly three times faster due to the added growing surfaces provided by the polyurethane foam.

### Treatment of a Sample to Remove a Target Compound

A sample to be treated, such as a waste stream from a pulp production facility, is selected for treatment. A target compound such as lignin present in the sample to be treated is identified based on its deleterious effects when present in the sample. A culture fluid from L. sulphureus is prepared as a 10 brix solution from which materials having a molecular weight above about 100,000 and those having molecular weight below about 500 have been removed using dialysis membranes of suitable pore sizes.

An aliquot of the sample to be treated is mixed with 1% by volume of the 10 brix bioremediation composition, and the rate of degradation of the target compound is measured by a standard analytical technique, such as HPLC. The test is conducted at a temperature at which the sample can be realistically treated, in order for the results to be applicable to the treatment of the sample itself. If the rate is much too slow to be practical under the constraints imposed by the particular remediation application, the test is repeated with 10% by volume of the 10 brix bioremediation composition; if it is much faster than necessary, the test is repeated with a correspondingly smaller volume of the 10 brix bioremediation composition. From this test, a suitable ratio of remediation composition to sample can be determined to accomplish the remediation objective, and a half life for the degradation of the target compound at that ratio can be calculated so that the length of time needed to achieve the objective can be estimated.

To treat the sample, the calculated amount of the 10 brix bioremediation composition is mixed thoroughly with the sample, and the mixture is maintained for the predetermined amount of time at the same temperature used for the initial tests. Optionally, the progress of the treatment can be monitored by analyzing aliquots of the sample during the treatment process.

1. A method for transforming an undesired organic material in a sample into a different chemical species that is less deleterious to the sample, said method comprising treating said sample with a composition prepared from a culture fluid produced by a brown rot fungal culture, wherein the amount of the composition is sufficient to cause a chemical transformation of said undesired organic material.

2. The method of claim 1, wherein the fungal culture is a culture of a Laetiporus species.

3. The method of claim 1, wherein the undesired organic material comprises an aromatic compound.

4. The method of claim 3, wherein the undesired organic material comprises an anisole or a phenol or a furan.

5. The method of claim 1, wherein the composition is substantially free of fungal cells and spores.

6. The method of claim 1, wherein the composition has been treated to remove or inactivate fungal cells and spores.

7. The method of claim 6, wherein the composition is prepared from a culture fluid produced by a Laetiporus sulphureus culture.

8. The method of claim 1, wherein said chemical transformation comprises a hydrolysis or an oxidation of said undesired organic material.

9. A method to reduce the concentration of an organic contaminant in an aqueous sample, said method comprising:
combining said aqueous sample with an amount of a composition prepared from a culture fluid from a brown rot fungus to form a mixture,
wherein said amount of said composition is an amount sufficient to cause a chemical transformation of said organic contaminant, and
incubating the mixture until the concentration of said organic contaminant in said sample is reduced by at least about 50% from the initial concentration of said organic contaminant in said sample.

10. The method of claim 9, wherein the brown rot fungus is a Laetiporus species.

11. The method of claim 9, wherein the organic contaminant comprises an aromatic compound.

12. The method of claim 11, wherein the organic contaminant comprises an anisole or a phenol or a furan.

13. The method of claim 9, wherein the culture fluid is substantially free of fungal cells and spores.

14. The method of claim 9, wherein the culture fluid has been treated to remove or inactivate fungal cells and spores.

15. The method of claim 14, wherein the culture fluid is from a Laetiporus sulphureus culture.

16. The method of claim 9, wherein said chemical transformation comprises a hydrolysis or an oxidation of said organic contaminant.

17. A bioremediation composition, which composition is prepared from a culture fluid produced by a brown rot fungus,
wherein said composition is substantially free of fungal cells and fungal spores,
and said composition is prepared without heating the culture fluid or the composition produced from it above about 80° C.

18. The composition of claim 17, wherein most of the organic compounds of molecular weight less than about 500 have been removed.

19. The composition of claim 17, which has a concentration of at least 10 brix.

20. The composition of claim 17, wherein the brown rot fungus is a Laetiporus species.

21. The composition of claim 17, wherein the brown rot fungus is Laetiporus sulphureus.
